(19) United States
(12) Patent Application Publication
(10) Pub. No.: US 2015/0237659 A1
(43) Pub. Date: Aug. 20, 2015

(54) Continuous Load Distributed Power Generation In A Mesh Networked System

(71) Applicant: Rajant Corporation, Malvern, PA (US)

(72) Inventors: Robert Joseph Schena, Wayne, PA (US); Kenneth Richard Brandmier, Hazle Township, PA (US); James Thomas Croyle, Downingtown, PA (US); David Bruce Haynie, Monroeville, NJ (US)

(73) Assignee: Rajant Corporation, Malvern, PA (US)

(21) Appl. No.: 14/472,770

(22) Filed: Aug. 29, 2014

Related U.S. Application Data
(60) Provisional application No. 61/941,874, filed on Feb. 19, 2014.

(51) Int. Cl. H04W 76/02; H04W 84/00; H04L 29/08; B60R 16/03; B60R 16/033

(52) U.S. Cl. CPC H04W 76/02; B60R 16/0307; B60R 16/033; H04L 67/12; H04W 84/005

(57) ABSTRACT

Energy generation and control systems to generate and deliver energy at the point of need, and use the so energy generated to enable individual points to form a mesh network. The disclosure also pertains to delivery of a predictable and steady load across a large mechanical system with distributed local-point energy generation and storage.

### TECHNICAL FIELD

The disclosure pertains to energy generation, in particular electrical power generation, and control systems to generate and deliver energy at the point of need and use the energy so generated to enable individual points to form a mesh network. The disclosure also pertains to delivery of a predictable and steady load across a large mechanical system with distributed local-point energy generation and storage.

### BACKGROUND

Historically, railroad freight cars have operated without a source or supply of electrical power. Essential control functions such as braking have been accommodated by use of air pressure lines routed through each car in a train. This has become inefficient due to the length and size of railroad trains, and due to the latency inherent in this means of supplying control to just one element of train control and engineering. In a 100-car freight train, it can take as much as 40 seconds to activate the air-operated brakes on the last freight car. This creates obvious safety and efficiency concerns. Additionally, there is no ready electrical power supply for more modern functions such as communications, positive train control, geo-location, car content-tracking, security, on-board diagnostics, and the like.

Without electrical power, there can be no safety lighting, such as the kind used on automobiles, trucks, ships, and other vehicles. On a very dark night, a railroad freight car can be all but invisible to any road vehicle that crosses its tracks. With freight trains exceeding a mile in length, a road vehicle can be completely unaware of a train crossing its path until it is too late.

Most railroads mandate periodic monitoring of freight cars on their tracks. This means that an engineer must dismount from the train periodically to inspect freight cars and their component parts (trucks, axles, bearings, and other parts) to ensure the cars are operating properly. Because of the great lengths of modern trains, it can take several hours to perform those inspections. Moreover, a defect in a wheel, truck, or axle may not be discovered until several hours have passed, miles of track are behind the train, and considerable damage has been done to both the train and the track it travels on.

The Rail Safety Improvement Act of 2008 (RSIA), passed in the wake of numerous devastating train accidents, mandates that passenger and Class I freight railroads install Positive Train Control (technologies designed to automatically stop or slow a train before certain human-error accidents occur) by the end of 2015. A power generator on board each railroad car, used in conjunction with a wireless mobile meshing network such as the Rajant Corporation Breadcrumb® Network described in U.S. Pat. No. 8,341,289, can provide an effective, integral platform for Positive Train Control, as well as other functions already mentioned. This disclosure addresses those issues.

In many electromechanical systems, chemical or mechanical energy is converted to electrical energy via generators. For small systems with predictable demand, this is fairly straight-forward: a generator is located at the best possible location based on the point of need and access to an engine or other source of mechanical power, and scaled to the fixed electrical demands of the system. The disclosure herein addresses the case of a very large system with a modular nature and variable demand, necessitating multiple local points of conversion. A variety of means are employed to coordinate power generation, storage, and load via network protocols. The result is a system in which the mechanical load on the engine changes smoothly, without unpredictable peaks and valleys in mechanical load.

The embodiments disclosed herein are illustrated in the context of railroad car power. Traditional railroad cars do not have an on-board source of electricity, but modern demands such as car tracking, content tracking, sensor arrays for health/performance monitoring, and other computer-age applications require electricity to be available. Electrical power cannot easily be bussed car to car, because of the need for cars to switch trains on a regular basis, and because of cost and reliability concerns. Adding a local (i.e., on-board) generator to a railroad car can provide power for the railroad car when the car is moving, but not when it is stationary. When the car is moving, the on-board generator's mechanical load is based on the instantaneous power demands of the car's electrical load. This can lead to large surges and “peaks and valleys” of power demand, where the peaks place additional mechanical load on the local generator and, in turn, on the locomotive engine. Modern trains optimize power output and prefer a steady load to one that is variable. There is also the opportunity to “harvest” wasted energy, such as during train braking. All of these factors lead to the requirement that local generators also have local power storage, to allow smoothing of the load profile, operation of at least some of the per-car electronics when the car is stationary, and regenerative braking.

The system disclosed herein couples local power generation with local power storage and a train-wide mesh network. The network not only serves to enable sensor monitoring and other computer-age activities, but it also serves as the control system for power generation. Each railroad car is equipped with a generator-battery module that includes a network-attached Nodal Power Supervisor. The Nodal Power Supervisor communicates the current status of its associated generator-battery module across the network: current power stored, current power load, near term scheduled loads, etc. All such data is collected by a Distributed Power Planner, which instructs each Nodal Power Supervisor when to run its generator, and when not to. This maintains the mechanical load from the distributed generators constant over time despite fluctuations in local loads.

The disclosed system also keeps the network alive in the event of a stoppage. The Nodal Power Supervisors are aware of the train's speed (based on generator output) and, thus, maintain a global understanding of the power available for generation, the power available in storage, and the current load demands. This allows the Distributed Power Planner to reduce the use of the network and less critical systems when the train is slowing, and restrict it to still slower updates and critical functions when the train is stopped.

Although the disclosure uses the example of a train for illustrative purposes, the disclosed system is applicable to other vehicles as well, and is not limited to trains or any other type of vehicle or conveyance.

### SUMMARY

In one aspect, the disclosure pertains to a vehicular wireless mesh network comprising a plurality of vehicles. Each vehicle has on board a generator for generating energy when the vehicle is operating, an energy storage device for storing at least a portion of energy generated by the generator, a network node including a wireless transceiver, a processor, and control software to enable the node to communicate with network nodes on other vehicles of the plurality. The network node is electrically connected to the generator and the storage device to receive energy from it.

The network may additionally comprise at least one sensor for sensing at least one parameter indicative of a state of the vehicle, the sensor being in communication with the network node. The energy storage device may be a battery. The storage device may automatically supply energy to the at least one sensor and the network node when the energy generated by the generator falls below a preselected value.

In one embodiment, the vehicles are railroad cars.

The vehicular wireless mesh network may further comprise a power conditioner between the output of the generator and electrical loads supplied by the generator for conditioning the generator output appropriately for each load. In another embodiment, at least one network node is connected to a wired network by a wired network connection, and may further comprise a network administrator module in communication with the wired network.

In a second aspect, there is disclosed a vehicular communication system comprising a generator on board a vehicle for generating energy when the vehicle is operating, an energy storage device on board the vehicle for storing at least a portion of energy generated by the generator, and a wireless transceiver to enable communication with locations remote from the vehicle. If desired, the system may include at least one sensor for sensing at least one parameter indicative of a state of the vehicle, the sensor being in communication with the transceiver. Where at least one sensor is included, the at least one sensor and the transceiver are connected to the generator and the storage device to receive energy from it.

In this aspect also, the vehicles may be railroad cars.

The energy storage device may be a battery, and the storage device may automatically supply energy to the at least one sensor and the transceiver when the energy generated by the generator falls below a preselected value.

A conditioner may be included between the output of the generator and loads supplied by the generator for conditioning the generator output appropriately for each load. In a third aspect, the disclosure pertains to system for generating electrical energy for use aboard a vehicle. The system comprises a generator including a rotor arranged for rotation with an axle of the vehicle, and a stator surrounding the rotor. The rotor is rotatable within the stator. The stator is arranged to remain in a substantially fixed position relative to the rotor as the rotor rotates with the axle of the vehicle. In an embodiment, the stator is arranged to remain in a substantially fixed position relative to the rotor by gravity as the rotor rotates with the axle of the vehicle.

The system may further comprise a power monitoring and control module for monitoring and controlling electric power generated by the generator, and the power monitoring and control module may be subject to a remote power management module, and may include a wireless transceiver in communication with the remote power management module.

In another aspect, the disclosure pertains to a system for distributed energy generation in a network having multiple independent nodes at which energy can be generated. At each node there is a generator for generating energy, an energy storage device for storing at least a portion of energy generated by the generator, a conditioning circuit, at least one load supplied by the generator, and a supervisor module for monitoring the state of the generator, the conditioning circuit, the storage device, and the load. The supervisor module may be connected to a network for exchanging information with a network-based energy management module.

The system for distributed energy generation may further include a network-based management module capable of determining the energy generation state of the network and based on the energy generation state scheduling generation and non-generation cycles for each node to present to the generators associated with the nodes a mechanical load that is substantially constant over time.

The system for distributed energy generation may further include a network-based energy management module capable of managing energy generation at each node when the generator associated with the node is not being driven, including retarding network management cycles and shutting down individual nodes as storage of energy at the node is exhausted.

The system for distributed energy generation may still further include a network-based energy management module capable of detecting and responding to mechanical load on the generators at each node, including issuing global instruction to all nodes to generate energy or stop generating energy depending on the mechanical load on the generators.

Any node can be designated to run the network-wide energy management module.

In the disclosed system for distributed generation, every energy generating node may be called upon to elect from among themselves a new node to run the energy management module, in event of the loss of a node currently running the energy management module.

### BRIEF DESCRIPTION OF THE DRAWINGS

FIG. 1 is a block diagram of a point-generation node, showing various elements that comprise the node.

FIG. 2 illustrates a plurality of nodes such as those illustrated in FIG. 1, interconnected to form an operating network.

FIG. 3 illustrates an operating network such as that illustrated in FIG. 2, in a low power condition with a non-operational node.

FIG. 4 illustrates an operating network such as that illustrated in FIG. 2, in which a node has become damaged.

FIG. 5 illustrates an operating network such as that illustrated in FIG. 2, in which power is reduced to conserve power while still maintaining the network.

FIG. 6a is a flow chart illustrating the operation of a distributed power planner that manages aspects of the operating network.

FIG. 6b shows a system with multiple point generation nodes and illustrates behavior of the network by frames as the behavior moves forward in time.

FIG. 7 is a flow chart illustrating the operation of the nodal power supervisor associated with a node as illustrated in FIG. 1.

FIG. 8 is a flow chart illustrating an election cycle initiated by a node to locate an operational distributed power planner.

FIG. 9 illustrates an exemplary railroad car wheel hub with a retention spring clip according to the prior art.

FIG. 10 illustrates the same exemplary railroad car wheel hub, but with a retention spring clip for use with an energy generator for providing locally generated energy to a railroad car.

FIG. 11 illustrates an energy generator that may be mounted to the retention spring clip and wheel hub of FIG. 10.

FIG. 12 shows the energy generator depicted in FIG. 11 as mounted to the retention spring clip of FIG. 10.

FIG. 13 illustrates the stator and rotor of the energy generator of FIG. 11 as assembled for operation, with the housing shown in phantom.

FIG. 14 is an enlarged view of the stator and rotor of the energy generator of FIG. 11 as assembled for operation, showing additional detail.

### DETAILED DESCRIPTION OF THE ILLUSTRATED EMBODIMENTS

It is to be understood that the figures and descriptions of the illustrated embodiments have been simplified to illustrate elements that are relevant for clear understanding, while eliminating, for the purpose of clarity, many other elements found in and known to the technical field. Those of ordinary skill in the art may recognize that other elements and/or steps are desirable and/or required in implementing the disclosed embodiments. However, because such elements and steps are well known in the art, and because they do not facilitate a better understanding of the illustrated embodiments, a discussion of such elements and steps is not provided herein. The disclosure herein is directed to all such variations and modifications to such elements and methods known to those skilled in the art.

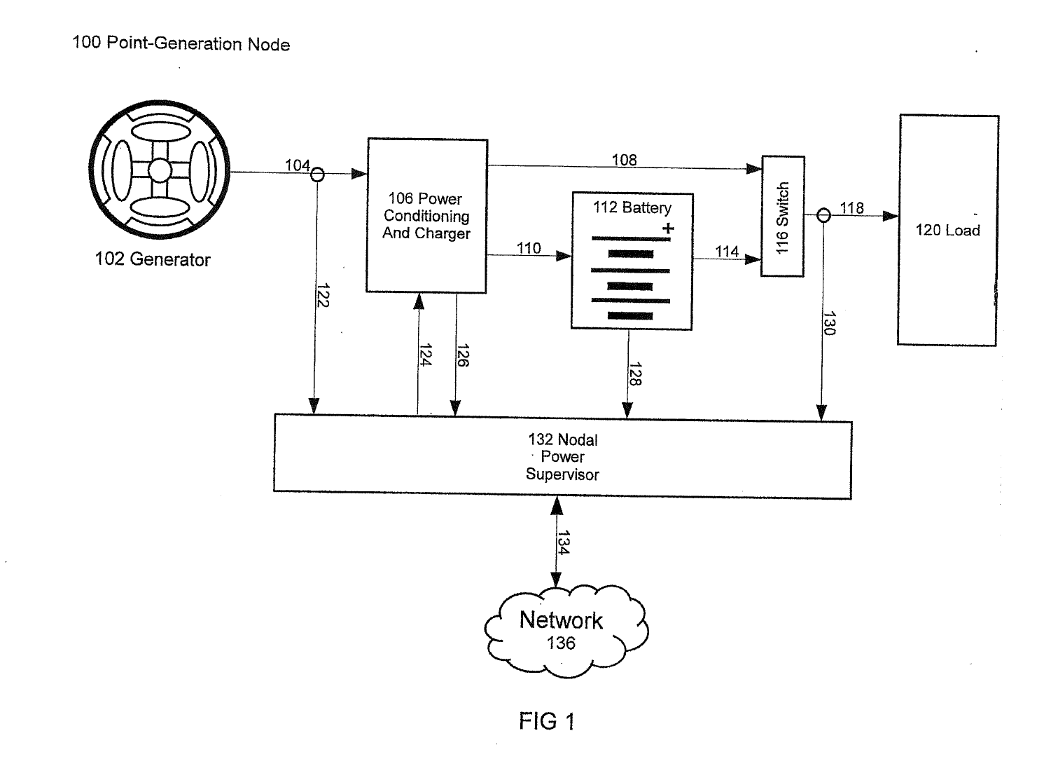

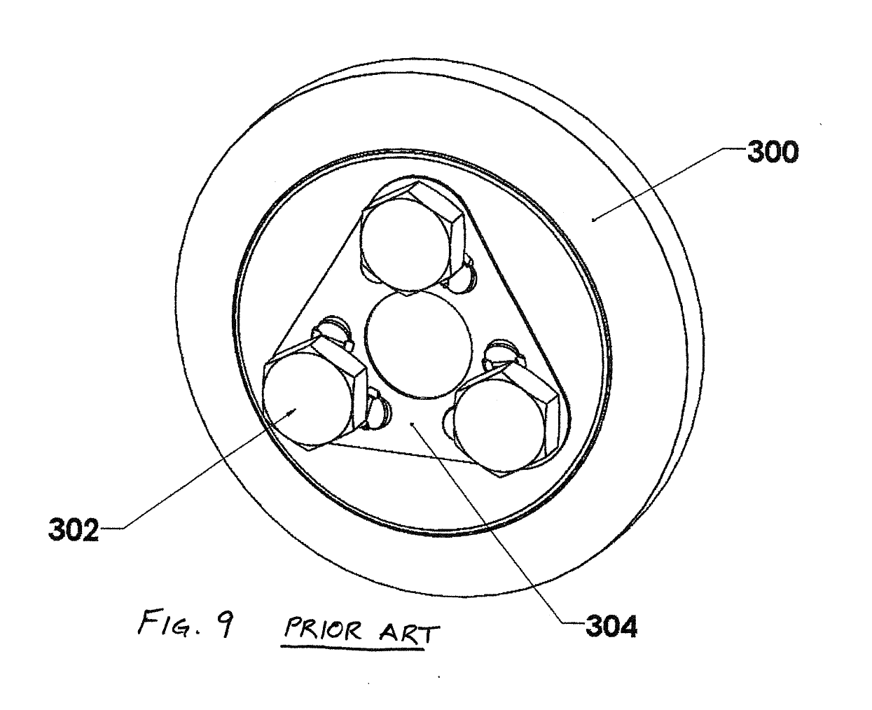

FIG. 1 illustrates a single Point-Generation Node (PGN) 100. As will be described in more detail below, a plurality of Point-Generation Nodes are connected together to form a mesh network. Although the preferred embodiment is illustrated using a mesh network, because a mesh network ensures reliability in critical and fault-prone applications, any network can be employed. Each Point-Generation Node 100 includes a generator 102 that can be attached to some locally available source of mechanical energy. In the preferred embodiment, generator 102 uses the rotation of a railroad car wheel to convert mechanical motion of the wheel to electric energy, but that is simply one way of generating electrical energy or electrical power. A design suitable for generator 102 is described below in connection with FIGS. 9-14.

Electricity from the generator 102 is transferred 104 to a power conditioning and charger module 106. Power conditioning and charger module 106 is an electronic module that will take electricity from the generator 102 and filter, rectify, or otherwise modify it so that it is conditioned for charging energy storage device in the form of battery 112. Other forms of energy storage devices, such as flywheels, capacitors, and other energy storage devices can be used. The details of the charging circuit are based on the specifics of the battery type, and one skilled in the art will understand how to design or select an appropriate charging circuit. A charging output 110 of power conditioning and charger module 106 is preferably directly connected to battery 112. The charging output 110 of the power conditioner/charger 106 always charges the battery 112 when the generator 102 is engaged; when the battery 112 is fully charged, power conditioner/charger 106 always disengages the generator 102.

A second output 108 of power conditioning and charger module 106 can optionally also be used to directly power a load 120 via output 118 of power switch circuit 116. Power switch circuit 116 is a standard battery backup switchover circuit. Switching takes place automatically and does not affect the output 118. When no generator power is present, the power switch 116 always supplies the load 120 from battery 112. Lighter loads may be powered from the battery 112 at all times.

Load 120 may comprise various types of equipment and sensors, including communications, illumination, Positive Train Control, geo-location sensing, car content-tracking, security, on-board diagnostics, and the like. Any suitable and necessary equipment and sensors can be included, depending on a user's needs.

Load 120 will preferably include a portable wireless mesh network device such as that shown in U.S. Pat. No. 8,341,289, and sold commercially by Rajant Corporation (the assignee of this application) under the trademark BreadCrumb®. A portable wireless mesh network device enables individual Point-Generation Nodes (PGN) 100 to communicate and exchange information by radio with other portable wireless mesh network devices in other Point-Generation Nodes and form a wireless mobile ad hoc network.

The Nodal Power Supervisor (NPS) 132 is tasked with monitoring and making network-managed changes to the point-generation node 100. The NPS 132 can measure generator output 104, power conditioning and charging status via connection 126, battery status via connection 128, and load status via connection 130. Based on a system-defined interval, referred to herein as the DPP Frame, the NPS will send via connection 134 a network status packet to a Distributed Power Planner (DPP) on the network 136. The network status packet contains the current status of the generator 102 via connection 122, status of the charger 106 (which may include thermal and other data), status of the battery 112, status of the current load 120, and any other local-specific information useful to the DPP (e.g., ambient temperature). Each Nodal Power Supervisor (NPS) 132 can monitor the state of its associated generator, power conditioning circuit, battery, and electrical load in its local area, and exchange information with the network-based Distributed Power Planner (DPP).

The DPP assesses the global demand for power and the load vs. storage conditions at each node, and instructs each NPS on when to draw power from the local generator and when to shut off power generation, free-wheeling the generator for minimal mechanical load on the engine. In this way, the global load on the system is kept fairly constant, rising or falling slowly, based only on the demands of the overall power consumption of the entire network.

In addition, the DPP analyzes global data to deal with situations in which the global demand either cannot be met, or needs to be lessened or even eliminated for other concerns (engine power peaking, safety issues, or other concerns that might arise). The DPP can schedule lower power generation for short time periods, relying on stored battery power, to respond to such issues. For longer periods of time, the DPP can put the network into a GUARDED or CRITICAL power state, in which the whole network responds by locally lowering power demands, lessening network activity, and conserving battery power.

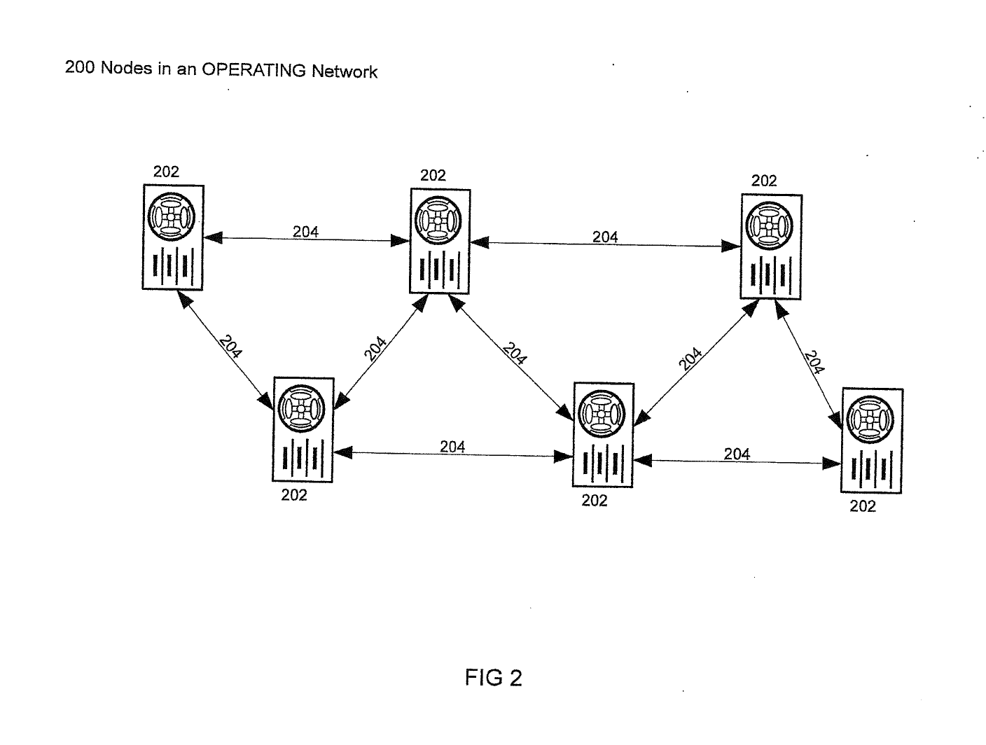

The DPP can reply to the network status packet with a simple command to start or stop the generator, which is relayed from the NPS 132 to the Power Conditioning and Charger module 106 via connection 124. The DPP can also reply with a new operating state, taking the system from OPERATING to a GUARDED or CRITICAL power state. This will take immediate effect on the node radio running the NPS application, and will also be broadcast across the local network, and acted upon by any hardware or applications capable of reacting to the system's different operating modes. GUARDED and CRITICAL states are interpreted by the NPS application when received. These states cause the node radio to enter a power-warning and power-critical state. The actual behavior is dictated by the specific applications running on each radio. Some applications may be shut down. The node radio will do its best to prevent unnecessary transmissions from occurring. It may instruct sensor applications to lower the rate of report on various sensors in the system, or stop them completely. Thus, sensor network applications running on the same network radio will be power-management aware. Devices attached to the local node radio, via Ethernet or serial connections, will have whatever power management features they possess integrated into each NPS application, so that they may be instructed to conserve power or “sleep” as much as possible, depending on the power state. The DPP application, upon entering a low power condition, will do things like increasing power management intervals to reduce the use of radio until the OPERATING state returns. FIG. 2 illustrates a small set of Point-Generation Nodes in an OPERATING mesh network 200. The relatively small size of the network is for illustration purposes only; real networks can contain hundreds of nodes. In the preferred implementation, OPERATING mesh network 200 is a wireless mesh network of the type described in U.S. Pat. No. 8,341,289, but the system will function over any network. The mesh configuration adds redundancy to the network, as can be seen. Even in a relatively linear array of nodes 202, such as a car-to-car network in a train, each node can reach several other nodes, as shown by arrows 204. In the preferred implementation, the wireless mesh network is self-optimizing.

FIG. 2 shows network nodes 202 with up to four other network nodes that can be reached directly. The number of nodes is usually not a problem, but too many nodes reaching each other will actually reduce the efficiency of the network, as transmissions will interfere with one another. The network size is practically unlimited, even with a single frequency, but a large network requires frequency reuse: many lower powered nodes rather than each node trying to reach every other node. In a mesh network, a transmission from the radio at node A to the radio at node B, for example, does not need to go directly from node A to node B. In fact, as long as each node radio can reach at least one other node radio and the mesh is unbroken, the radio at node A simply needs to transmit to some other node on the mesh, which will then route its traffic to the radio at node B. The end result of this is that mesh radios often work better at lower power. By way of comparison, a large network with point to point access will have a single link that, at best, can achieve a throughput T, where T is based on the best-case single radio-to-radio performance.

However, throughput T is difficult, if not impossible, to realize using Carrier Sense Multiple Access with Collision Avoidance (CSMA/CA) wireless protocols like 802.11, which is the preferred protocol as noted in U.S. Pat. No. 8,341,289. With CSMA/CA, each transmitter looks for other transmissions before itself sending data, but it is impossible to prevent the occasional “collision,” with two or more devices transmitting at the same time. Hence, as the number of nodes and the rate of traffic increases in a fully point-to-point single link scenario, throughput actually drops to the point of breaking, and there is a loss proportional to the size of the network. In addition, radio protocol degrades; over the air performance drops off as the distance between any two radios increases, so the single link performance T is never achieved. For single link scenarios, a higher power transmitter needs to be used, and each radio in the network has to have enough power to reach every other radio in the network. When a mesh network is configured at minimal power, each node will on the average need to reach two others, which is sufficient. So for N nodes, the aggregate link performance is as high as T*N/3, rather than T. Adding new nodes does not reduce this per link performance, as collisions can only happen between at most three nodes, so there is no increase in data loss with increases in the number of nodes N. Also, the transmission distance is much shorter than for a high powered single link network, so there is a much higher probability that each link will operate at the full throughput T, rather than in some degraded mode.

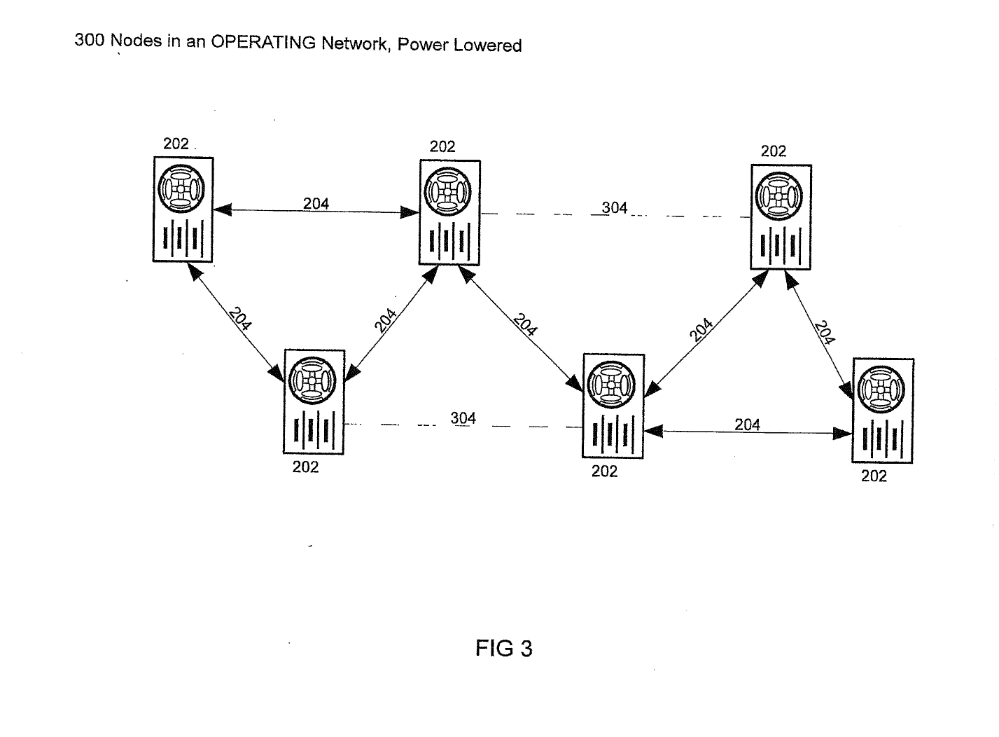

Moreover, since the power output of each node varies only with node to node distance, overall transmission power is substantially lower. In practical mesh networks, each node will be set to reach something more than just one or two other nodes, trading reliability for aggregate performance. Ordinarily, the nodes used in the preferred embodiment the nodes used will automatically adjust power output to strike an optimal balance between redundancy and power. FIG. 3 shows the same OPERATING network as FIG. 2, but power to network 300 is lowered to the point that connections 304, shown in dashed lines, are not operational, although they could be made operations if necessary by increasing power.

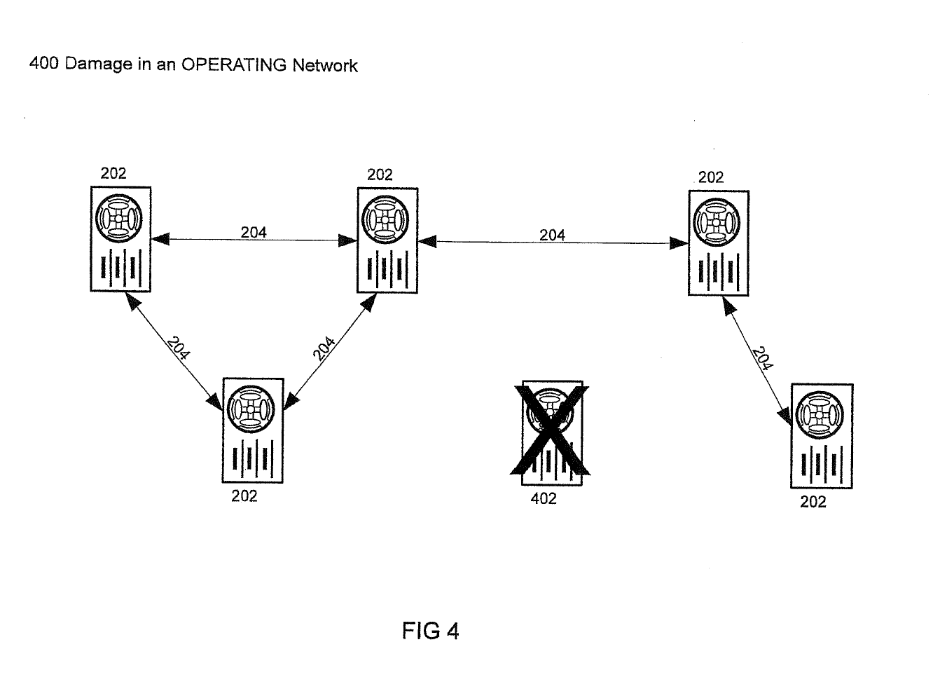

FIG. 4 illustrates the same OPERATING Point-Generation Network, but this time with a damaged node. Even with the damaged node 402, the network 400 is “self-healing,” i.e., the network is maintained due to the mesh redundancy. Other forms of redundancy and fault protection can offer this as well. Using wireless communication between nodes and a self-healing mesh, the Point-Generation Network can deal with changes in the network configuration, such as the loss or addition of nodes (railroad cars removed or added to the train) without user intervention.

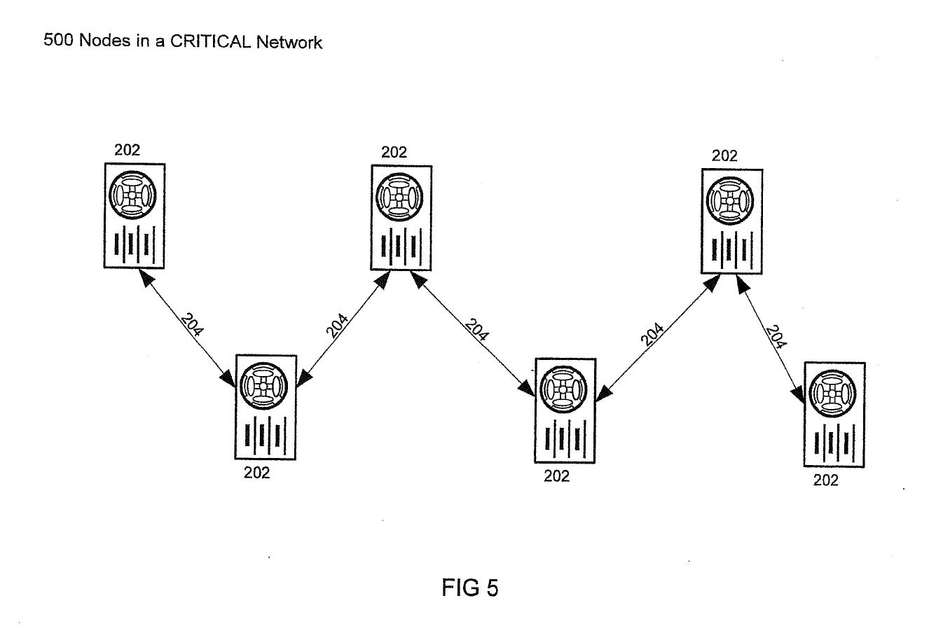

FIG. 5 illustrates the same Point-Generation Network in CRITICAL mode. In CRITICAL mode, power to each node 202 is reduced to a level that will ensure that each node 202 can reach at least one other node, as indicated by arrows 204, and that the network 500 itself is maintained. In CRITICAL mode, the DPP has signaled a CRITICAL state, and upon receipt of the signal from the DPP each NPS signals the mesh interface to go into the low power state. This will cause the transmit power management software to move to a minimal-node optimization point, rather than the usual point of optimizing for a blend of reliability and power use. In addition, the DPP will increase the DPP Frame, which sets the report rate for nodes in the system. In a low power state, allowing reporting at twice the normal interval (i. e., at half the number of times) will save as much as 40-50% power, since most of a node's power is spent on data transmissions. At the NPS, entering the lower power mode will cause the NPS application to notify the radio's operating system about the power conditions. Depending on the particular node configuration, this may result in the radio itself slowing or ending sensor polling activity. It may result in low power messages being sent to an in-radio application process, which does the power management for attached sensor and other job-specific data. Or, with cooperation from external equipment, these external items, too, can participate in the power savings and power-down protocols.

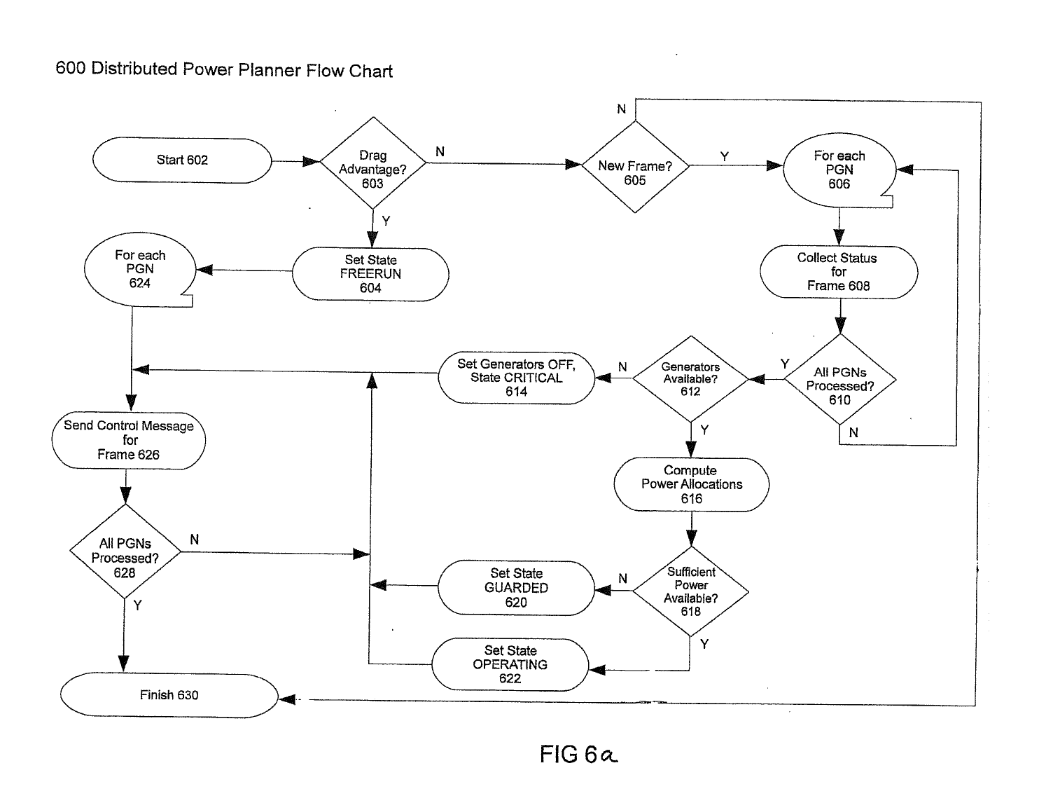

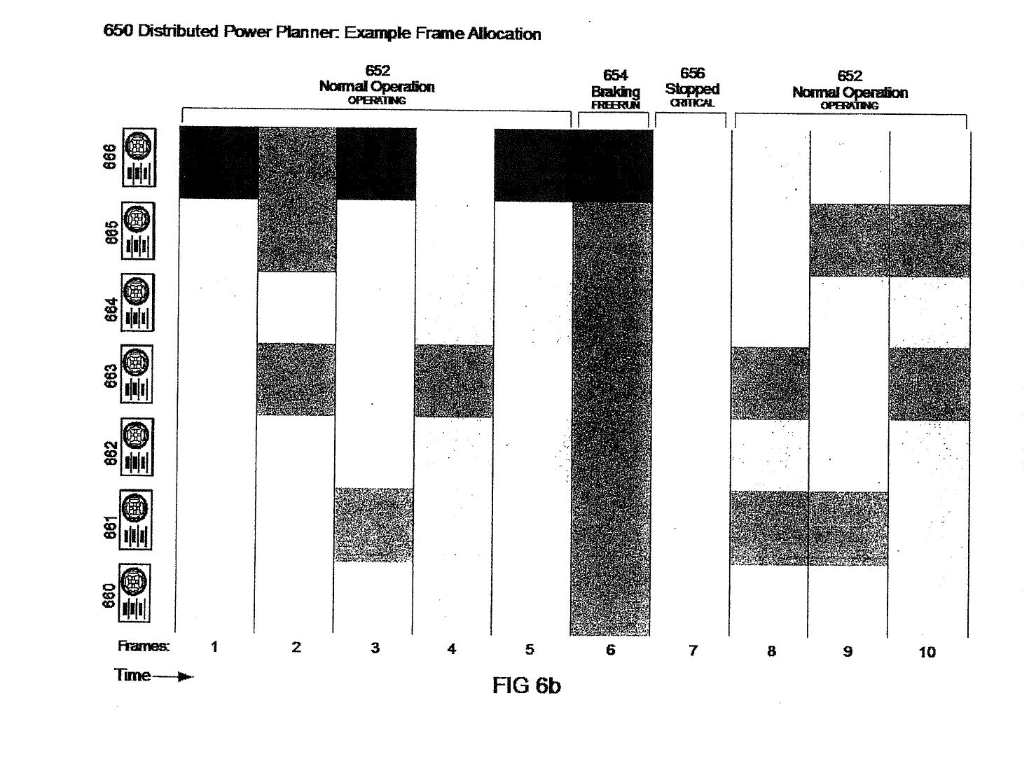

FIG. 6a is a flow chart 600 that illustrates operation of the Distributed Power Planner (DPP) on network 136. The process starts 602 with a check 603 to see if a “Drag Advantage” is called for. In some cases, such as braking, mechanical drag of the system may be advantageous. In this case, the operating state is set 604 to a FREERUN state. In the FREERUN state, each Nodal Power Supervisor (NPS) 132 runs its generator as long as its associated battery is not fully charged or there is a non-trivial local load on the generator. Of course, the generator must be able to operate (i.e., the railroad car is not stationary). The FREERUN state 604 is invoked immediately, rather than at the start of a DPP Frame, since the DPP needs no information from any or all of the other nodes to invoke this state, just a system-level command.

Other changes occur at the change of a DPP Frame. The system has an installation-defined DPP Frame length, the quantum for changing system settings throughout the network, and will not seek to make changes during this period. Only the DPP itself is actually concerned about Frames; each NPS simply responds to DPP requests as they come in. The DPP will check 605 to see if a new frame has started. If not, this part of the process is complete 630. The DPP Frame length is a performance tuning parameter. This is set up based on the needs of the installation itself, which may be different even for similar systems, depending on the payload of the network, the capacity of the local backup power systems, the number of nodes in a network, etc. This information is considered, along with some performance analysis of a working system, during the install and set up of a network using the embodiments herein described.

When a new Frame is started 605, the DPP loops 606 over each Point-Generation Node 100. The DPP requests and processes 608 a status message from each node 100, indicating generator operation, charger and battery state, and current electrical load. This continues until all nodes 100 have been processed 610.

The collection loop 606-610 answers the most important question: are the generators operating? If not, the operating state is set to CRITICAL and the generators are switched off 614. If the generators are operating, a more complex calculation is needed to allocate power distribution 616. This will take into account the last load. No overly-abrupt changes are permitted to the mechanical load, and there can be system-imposed limits as well. This calculation at 616 looks at the currently reported electrical demand, the power available from the generators, and the state of each battery. Nodes with the highest demand for power are scheduled to generate power during the period of the next Frame; the level of demand, urgency of demand, and previous state are taken into account for the next Frame's settings.

Another part of the DPP's process is to account for all expected PGNs in the system. If a Point-Generation Node (PGN) 100 has not reported within an installation-dependent number of Frames, the DPP will send a REPORT message to that node, allowing the mesh network to attempt to find it. If it is not found, a human operator will be notified of the problem, based on installation-dependent rules.

FIG. 6b shows a system with seven PGNs designated by reference numerals 660-666, and illustrates network behavior by frames over time. In FIG. 6b, the frames are numbered as 1 through 10, with higher numbers being considered to occur later in time than lower numbers. In FIG. 6b, Frame 1 represents several frames of normal operation 652, and for illustrative purposes PGN 666 is depicted as presenting a high load, PGNs 664 and 660 are depicted as presenting low loads, and the rest (PGNs 661, 662, 663, and 665) are off. Moving to Frame 2, PGN 666 is instructed by the DPP to go to a moderate load, while PGNs 665 and 663 also present moderate loads. On each new frame, the DPP instructs each PGN either to present no load or to present a specific load level, based on the overall demands of the system weighed against the needs of the specific PGN. At Frame 6, the DPP has executed a braking command by setting the FREERUN state 654. In this state, PGN 666 is presenting a high load, and PGNs 660-665 are presenting moderate load. Of course, if one of the PGNs did have a full battery, it would not present a load and, thus, not harvest “free” power from the braking process. Next, at Frame 7, the vehicle is shown as being stopped 656. The DPP has issued a CRITICAL state signal, and no generator is presenting a load. At that time, each PGN is on battery. Moving along to Frame 8, the system is illustrated as having resumed OPERATING mode 652. In Frame 8, PGNs 666 and 662 have been scheduled for light load, PGNs 663 and 661 have been scheduled for moderate load, and PGNs 660, 664, and 665 are not presenting any load to the system. The key is that, in each state, the load on the PGNs is, on average, approximately the same. In a large train, this would scale across many more than seven cars, but would work in much the same way.

A very large system might stagger changes. For example, half the PGNs might change their load presentation on even frames, and the other half on odd frames. Many different load allocations are possible, and can be tailored to the specific network and electrical load being implemented. The architecture and basic operation, however, remain the same whether, for example, seven or even 700 PGNs are involved.

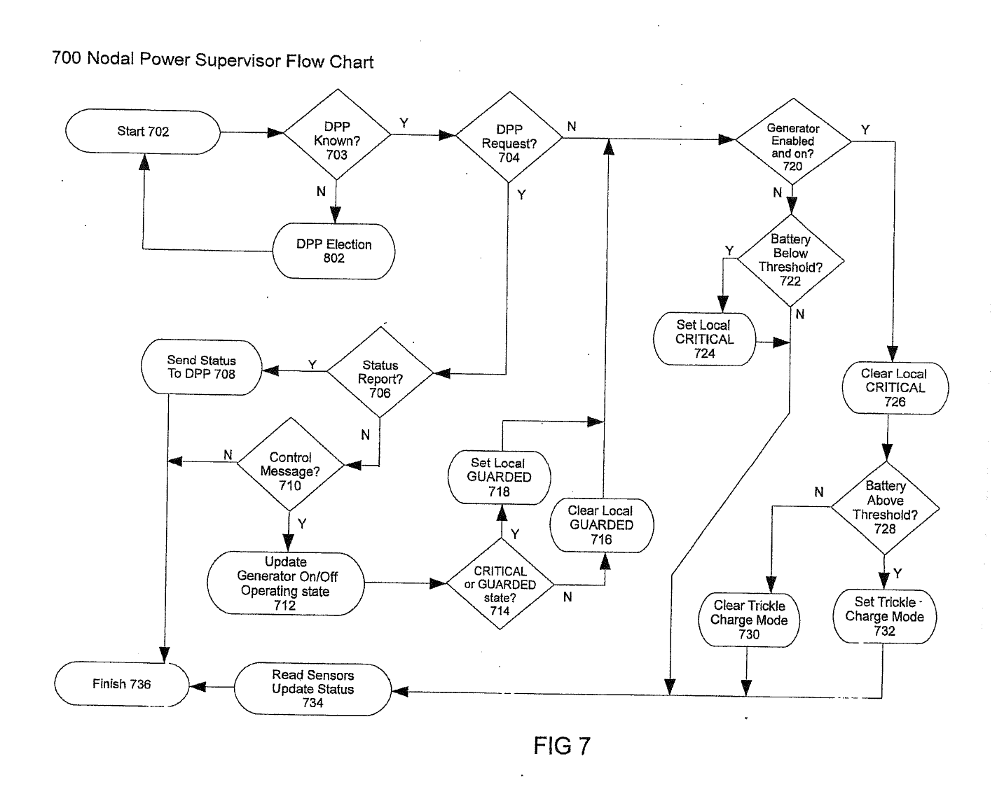

FIG. 7 is a flow chart 700 that illustrates operation of the Nodal Power Supervisor. At Start 702, the NPS first looks 704 for a request from the DPP. If there is a request, it may be for a status report 706. For a status report, the working set of sensor data is packetized and sent 708 to the DPP, completing 736 one cycle of the NPS. If the request is not a status report request, it could be a request 710 for a Control Message. If not, the NPS cycle is again complete 736. In the case of a Control Message 710, the NPS looks at critical information in the message first. Of primary concern is the global state, as well as the current generate/no generate state 712. If the generator 102 is not to be used, it is switched off for the next DPP Frame; if the generator 102 is to be used it is switched on for the next DPP Frame. Additionally, if either a CRITICAL or GUARDED state exists globally, a GUARDED state is set for local devices, indicating a present concern over power conditions 718 and issuing local power conservation settings where appropriate. If the network is not in either GUARDED or CRITICAL state globally, the local state is cleared of GUARDED 716, and local smart devices can run in a normal state. By local smart devices is meant any kind of device operating from the local power source that may be able, based on its design, to respond to power management controls. Perhaps an installation is using a customer-supplied sensor network, with its own network management computer. That computer would ideally be able to participate in the power management process. Maybe that same node is also powering a lamp for maintenance workers. If the lamp is accidently left on, it may not be able to respond to the power management protocol defined as part of the DPP. Local smart devices would also be able to tell the network just how critical their functions are. This is useful both for power management—deciding which devices need to be left powered as long as possible—and also for generating alerts to human supervisory personnel, in case such a device starts to malfunction or is simply lost to the network.

After the control update 712, or in a monitoring cycle of the NPS (when DPP Request message has been received 704), the status of the generator 102 is checked 720 to determine whether it is enabled and on, and producing enough power. If not, and if the battery has fallen in charge below a certain threshold 722, the NPS sets 724 the local CRITICAL operating mode. This instructs any less important/mandatory local smart devices to reduce power or shut off, where possible. If the generator 102 is enabled and on 720, the local CRITICAL mode is cleared 726 and devices may operate again. The battery threshold is also checked 728. If the battery charge is above another system threshold the charger is put into trickle-charge mode 732. If not, the charger is taken out of trickle-charge mode 730. Trickle-charging nodes use much less power than nodes that are in a full-charge mode, so many more nodes can be charging in a DPP Frame if they are in trickle-charge mode.

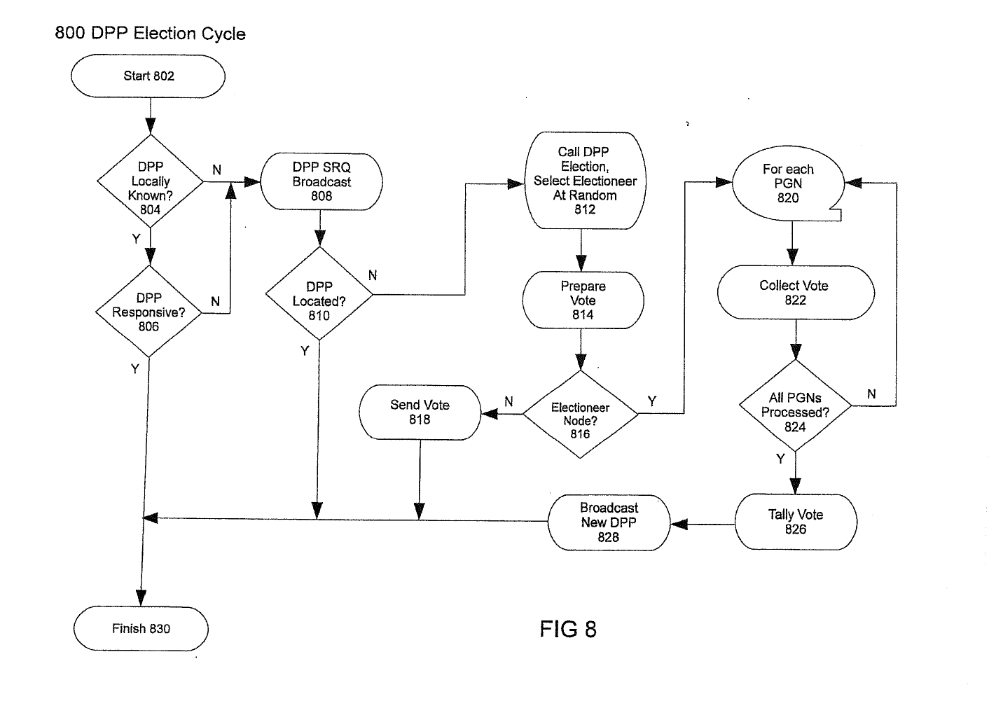

FIG. 8 is a flow chart that illustrates a Distributed Power Planner Election Cycle 800. The DPP can be permanently assigned to any network node. For example, a human supervisor may run the DPP locally on a system monitoring computer. However, the DPP can also run on any node in the network, and it may need to. A DPP node may fail or need to be taken down, or perhaps the network may be broken by a multi-node failure. It is expected that even two separate network segments running independent DPP nodes will perform better than an uncoordinated system.

Upon Start 802, the Election Cycle 800 is called by a node 100 to find a working DPP. If a DPP is known 804 to the local node, that DPP is tested for responsiveness 806. If it is functioning, no election need run. If the DPP is not known locally 804 or the known DPP is not responsive 806, a DPP Service Request is broadcast 808 to the network. The Service Request requests a known working DPP from the network. Nodes receiving a Service Request either will respond with the DPP address or will re-broadcast the request. If the request returns a DPP address, no election is held 810.

However, if no node can produce a working DPP 810, an election must be held 812. An electioneer is selected 812, which can either be the first node sending the DPP service request, or a random election held among the network nodes. In such a random election, each node sets a random delay before broadcasting an Electioneer Petition. Any node receiving an Electioneer Petition Broadcast stops its own request process. The goal is to make the actual DPP selection efficient. All nodes need not participate, and that does not have to impair network efficiency.

Once an Electioneer is elected 812, every node prepares its vote 814. Every node votes for itself, including information on how critical it is to the network, its ability to run the DPP, its centrality in the network (average number of mesh hops on received packets, etc.), the quality and capacity of its power supply, etc. Votes from each of the nodes are sent 818 to the Electioneer node on request.

In the Electioneer node, each node's vote is collected 820-824 and tallied 826. The vote determines the first round eliminations. Lower rated nodes are eliminated, but their proximity to a higher rated node will raise that node's profile in the second round. After the votes are tallied 826, the Electioneer broadcasts 828 a New DPP message to the network, and the process terminates 830. As well as the need to call a DPP election when a network splits, it is necessary to call an election when two networks merge. If one network has a console-based DPP, that node is always selected, based on it having a very high priority. A console-based DPP is ordinarily a human-monitored DPP node. This can be the DPP application running on a designated radio that's wired via Ethernet to a PC or laptop, to facilitate human monitoring and control of the network. In the preferred embodiment, there is usually a human monitor running other BCAPI based applications that permit other kinds of network monitoring (health, performance, etc.). The DPP is an extension of this. It's also possible for DPP application to run directly on that personal computer. Part of a network configuration is designating the default DPP, if a monitoring station is part of that network installation. Most systems will have only one manned DPP console. It's possible to monitor the DPP from anywhere in the network, but each network has only one DPP running In a locomotive network, for example, two passing trains will have different security keys, so their networks will not attempt to merge. In the current design, there is only one possible DPP console in the network; if two networks, each with a DPP console were to merge, a properly set up network will have, in its configuration data, the network address of the designated DPP console. If there is no designated console, the DPP election process would choose one or the other of the two manned consoles to actually run the DPP application.

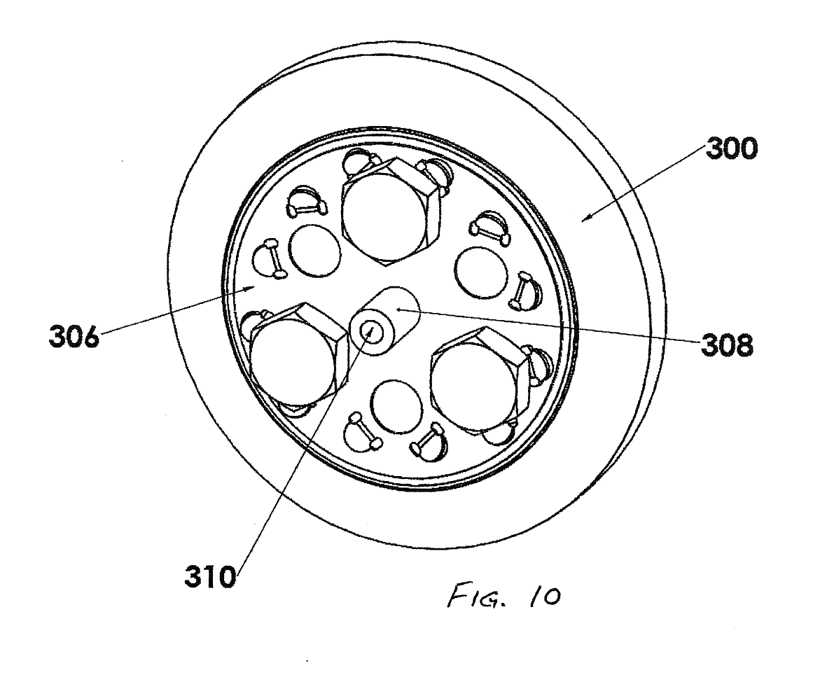

FIGS. 10 through 14 illustrate a power generator 102 that can be used to generate power for each of the network nodes described above. An object is to provide a railroad car generator that does not need costly and labor-intensive installation and maintenance. The power generator is described and illustrated in connection with a wheel of a railroad car, but it should be understood that the power generator is not limited to railroad cars but may be adapted for operation with other vehicles, such as road trailers, that typically do not have an on-board source of power.

FIG. 9 illustrates a wheel hub and retention spring clip of a conventional railroad car according to the prior art. A typical railroad car will have a truck that supports axles and wheels for rotation relative to the car. Typically, wheels are mounted to the axles and held in place by a hub 300 mounted to the wheel (not shown) by bolts 302. A retention spring clip 304 is used to hold the bolts in place and prevent them from backing out of hub 300 due to vibration when the railroad car is in motion.

In the illustrated embodiment, the power generator is driven by rotation of one of the wheels. Of course, as the wheel rotates, so does hub 300. In order to couple rotation of the wheel to the power generator, the conventional retention spring clip 304 is replaced by a new retention spring clip 306, as shown in FIG. 10. Retention spring clip 306 is preferably, although not necessarily, a “universal” clip to accommodate different bolt patterns sometimes used on different railroad cars. The retention spring clip 306 has a coupling shaft 308 that extends from the outer face of retention spring clip 306 and is co-axial with the wheel and the axle on which the wheel is mounted. In that manner, rotation of the wheel imparts equal rotation to coupling shaft 308.

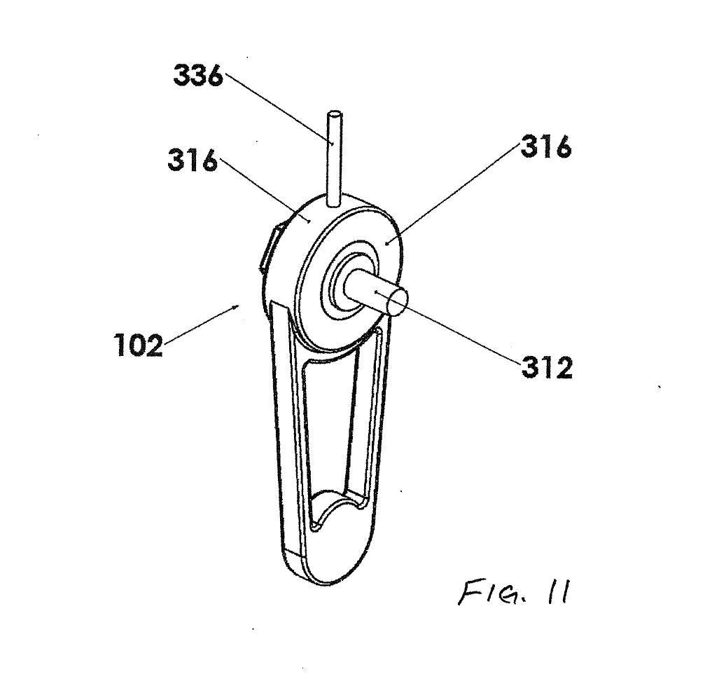

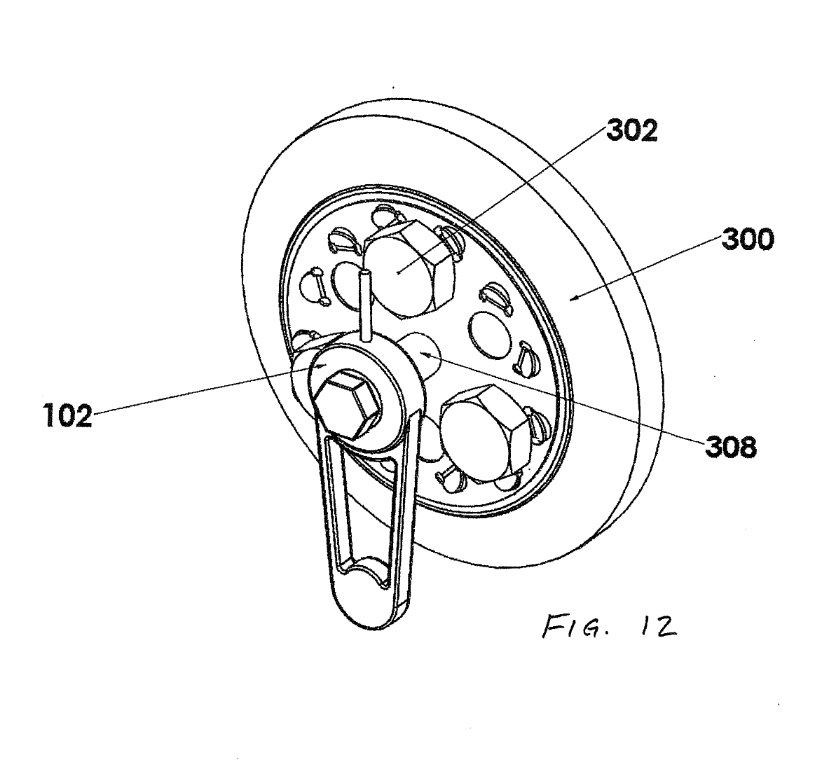

Coupling shaft 308 has a bore 310 that is internally threaded to receive the drive shaft 312 of the power generator 102. The power generator 102, with drive shaft 312 extending from the generator housing 316, is shown in FIG. 11. Drive shaft 312 is sized to fit bore 310 in coupling shaft 308, and is externally threaded to engage the internal threads in bore 310. Once drive shaft 312 is threaded into coupling shaft 308, as illustrated in FIG. 12, rotation of the wheel caused by movement of the railroad car will cause the drive shaft to rotate as the wheel rotates.

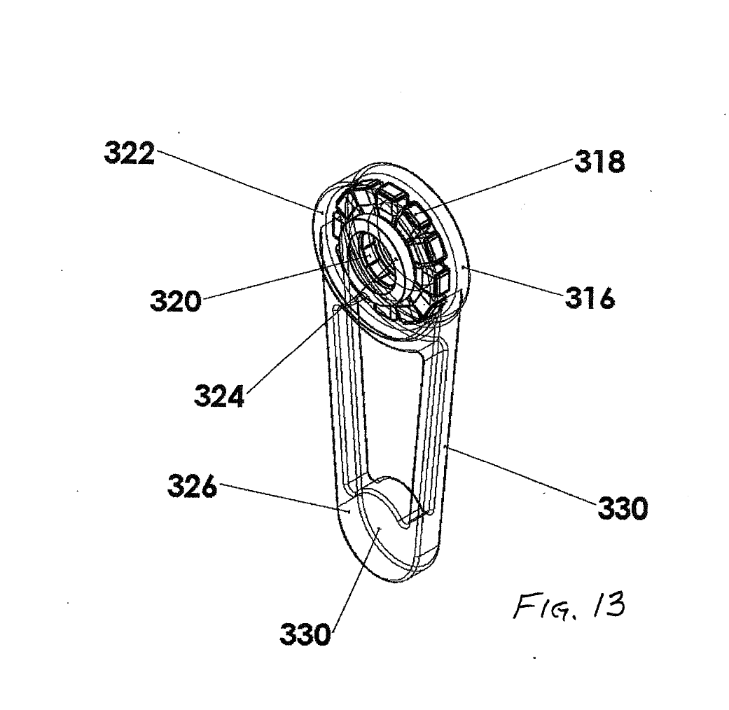

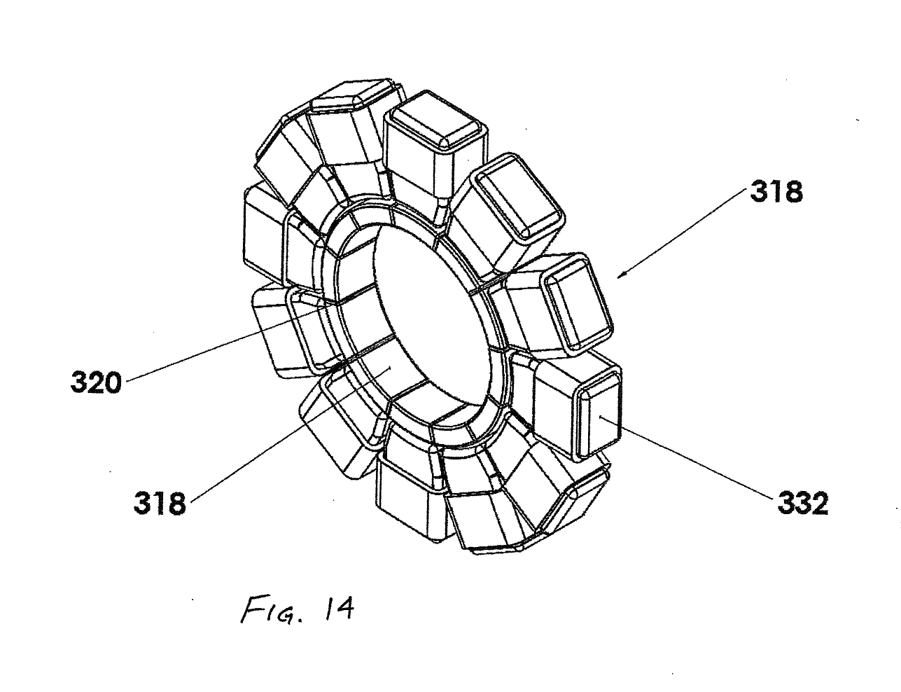

Drive shaft 312 is coupled to the power generator 102, which comprises a stator 318 and a rotor 320 arranged to rotate within stator 318, as seen in FIGS. 13 and 14. Stator 318 and rotor 320 are housed within generator housing 316, which has a cylindrical portion 322 surrounding the stator. Although the portion 322 of generator housing 316 is illustrated as cylindrical, any shape that accommodates stator 318 and rotor 320 can be used.

Stator 318 is located within housing 316. Rotor 320 is coaxial with and located within stator 318, and is rotatably movable relative to stator 318. Preferably, stator 318 and rotor 320 are coupled together for relative rotation by bearings 324, which enable rotor 320 to rotate freely within stator 318 when rotor 320 is driven by rotation of drive shaft 312 when the railroad car is moving.

Both housing 316 and stator 318 are supported by the axle hub 300. Stator 318 remains more or less stationary relative to rotor 320 when the railroad car is moving by virtue of stabilizing weight 326. Weight 326 is located within an extension 328 of housing 316, and is radially separated from the axis of rotor 320. Weight 326 may be located in a portion 330 of housing 316 connected to cylindrical portion 322 by struts 330. Any suitable structure for mounting weight 326 in housing 316 may be used, as long as weight 326 does not move relative to either housing 316 or stator 318.

Weight 326 serves to keep generator 102 and stator 318 more or less fixed relative to rotor 320. Weight 326 acts like a pendulum, and urges housing 316, within which stator 318 is fixedly mounted, to maintain a position in which weight 326 remains lower than stator 318 and causes stator 318 to maintain a fixed position relative to rotor 320. Thus, as rotor 320 is driven by drive shaft 312, which is driven by coupling shaft 308 when the railroad car is in motion, stator 318 remains relatively fixed. In that manner, rotation of rotor 320 within stator 318 is able to generate electrical power. Those skilled in the art will recognize that other ways of ensuring relative rotation between rotor 316 and stator 318 can be used, such as but not limited to magnetic gearing, counter-rotation of the rotor and stator, or other techniques.

Stator 318 comprises a plurality of wire coils 332 arranged circumferentially around and spaced radially from the axis of drive shaft 312. The coils 332 may be interconnected electrically in any desired fashion, such as delta or wye fashion. Rotor 320 comprises a plurality of magnets 334, also arranged circumferentially around and spaced radially from the axis of drive shaft 312. The outer diameter of rotor 320 is less than the inner diameter of stator 318, so that rotor 320 and bearings 324 fit within stator 318 and can rotate freely within stator 318. Rotation of rotor 320 within stator 318 causes the magnets 334 to move relative to the coils 332, thereby inducing electric current to flow in the coils 332. Electric current generated can be drawn off by power cable 336 (best seen in FIG. 11) and conducted to one or more electrical loads, such as power conditioning and charger circuit 106.

Generator 102 can provide electrical power to activate electrically-operated brakes and other electrical systems on the railroad car on which it is mounted, and can provide power for lighting to vehicles not equipped with a source of power.

Sensors (not shown) placed on the cars' trucks can detect unusual wear, vibration, or heat and alert the train engineer of potential problems with the car before massive and expensive damage is done to the railway or car. The sensors can also detect and report speed and other data critical to the safe and efficient operation of the railroad. Power provided by generator 102 can supply the sensors, and also enable real-time diagnostic monitoring of rail car and track diagnostics, such as heat, friction, speed, wear, and vibration, which in turn can reduce damage to track and car and reduce man-hours used to perform superficial inspections.

The system described herein may be embodied in other specific forms without departing from the spirit or essential attributes thereof and, accordingly, reference should be made to the appended claims, rather than to the foregoing specification, as indicating the scope of the invention.

Although the disclosed embodiments have been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the claims as set forth hereinafter.

1. A vehicular wireless mesh network comprising
a plurality of vehicles, each vehicle having on board
at least one generator for generating energy when the vehicle is operating,
an energy storage device for storing at least a portion of energy generated by the generator,
a network node including a wireless transceiver, a processor, and control software to enable the node to communicate with network nodes on other vehicles of the plurality,
the at least one sensor and the network node being electrically connected to the generator and the storage device to receive energy therefrom.

2. The vehicular wireless mesh network according to claim 1, wherein the vehicles are railroad cars.

3. The vehicular wireless mesh network according to claim 1, wherein the energy storage device is a battery.

4. The vehicular wireless mesh network according to claim 1 wherein the energy is electrical energy, and further comprising a power conditioner between the output of the generator and electrical loads supplied by the generator for conditioning the generator output appropriately for each load.

5. The vehicular wireless mesh network according to claim 1, further comprising at least one sensor for sensing at least one parameter indicative of a state of the vehicle, the sensor being in communication with the network node.

6. The vehicular wireless mesh network according to claim 1 wherein the energy is electrical energy and the energy storage device automatically supplies electrical power to the network node when the energy generated by the generator falls below a preselected value.

7. The vehicular wireless mesh network according to claim 1, wherein at least one network node is connected to a wired network by a wired network connection.

8. The vehicular wireless mesh network according to claim 7, further comprising a network administrator module in communication with the wired network.

9. A vehicular communication system comprising
a generator on board a vehicle for generating energy when the vehicle is operating,
an energy storage device on board the vehicle for storing at least a portion of energy generated by the generator,
a wireless transceiver to enable communication with locations remote from the vehicle,
the transceiver being electrically connected to the generator and the storage device to receive energy therefrom.

10. The vehicular communication system according to claim 9, wherein the vehicles are railroad cars.

11. The vehicular communication system according to claim 9, wherein the energy storage device is a battery.

12. The vehicular communication system according to claim 9, further comprising a power conditioner between the output of the generator and electrical loads supplied by the generator for conditioning the generator output appropriately for each load.

13. The vehicular communication system according to claim 9, further comprising at least one sensor for sensing at least one parameter indicative of a state of the vehicle, the sensor being in communication with the transceiver.

14. The vehicular communication system according to claim 9, wherein the energy storage device automatically supplies electric power to the at least one sensor and the transceiver when the energy generated by the generator falls below a preselected value.

15. A vehicular monitoring system comprising
a generator on board a vehicle for generating energy when the vehicle is operating,
an energy storage device on board the vehicle for storing at least a portion of energy generated by the generator,
a wireless transceiver to enable communication with locations remote from the vehicle,
at least one sensor for sensing at least one parameter indicative of a state of the vehicle, the sensor being in communication with the transceiver,
the at least one sensor and the transceiver being electrically connected to the generator and the storage device to receive energy therefrom.

16. The vehicular monitoring system according to claim 15, wherein the vehicles are railroad cars.

17. The vehicular monitoring system according to claim 15, wherein the energy storage device is a battery.

18. The vehicular monitoring system according to claim 15, further comprising a power conditioner between the output of the generator and electrical loads supplied by the generator for conditioning the generator output appropriately for each load.

19. The vehicular monitoring system according to claim 15, wherein the energy storage device automatically supplies electric power to the at least one sensor and the transceiver when the energy generated by the generator falls below a preselected value.

20. A system for generating electrical energy for use aboard a vehicle comprising a generator including
a rotor arranged for rotation with an axle of the vehicle, and
a stator surrounding the rotor, the rotor being rotatable within the stator,
the stator being arranged to remain in a substantially fixed position relative to the rotor as the rotor rotates with the axle of the vehicle.

21. A system for generating electrical energy for use aboard a vehicle according to claim 20, wherein the stator is arranged to remain in a substantially fixed position relative to the rotor by gravity as the rotor rotates with the axle of the vehicle.

22. The system for generating electrical energy for use aboard a vehicle according to claim 20, further comprising a power monitoring and control module for monitoring and controlling electric power generated by the generator.

23. The system for generating electrical energy for use aboard a vehicle according to claim 20, wherein the power monitoring and control module is subject to a power management module and includes a wireless transceiver in communication with the power management module.

24. A system for distributed energy generation in a network having multiple independent nodes at which energy can be generated, comprising
a generator at each of a plurality of said nodes for generating energy,
an energy storage device at each of said plurality of nodes for storing at least a portion of energy generated by the generator,
a conditioning circuit at each of said plurality of nodes,
at least one load at each of said plurality of nodes supplied by the generator,
a supervisor module at each node for monitoring the state of the generator, the conditioning circuit, the storage device, and the load, the supervisor module being connected to a network for exchanging information with a network-based management module.

25. The system for distributed energy generation according to claim 24, further comprising a network-based energy management module capable of determining the energy generation state of the network and based on the energy generation state scheduling generation and non-generation cycles for each node to present to the generators associated with the nodes a mechanical load that is substantially constant over time.

26. The system for distributed energy generation according to claim 24, further comprising a network-based energy management module capable of managing energy generation at each node when the generator associated with the node is not being driven, including retarding network management cycles and shutting down individual nodes as storage of energy at the node is exhausted.

27. The system for distributed energy generation according to claim 24, further comprising a network-based energy management module capable of detecting and responding to mechanical load on the generators at each node, including issuing global instruction to all nodes to generate energy or stop generating energy depending on the mechanical load on the generators.

28. The system for distributed energy generation according to claim 24, in which any node can be designated to run the network-wide energy management module.

29. The system for distributed energy generation according to claim 24, in which every energy generating node is called upon to elect from among themselves a new node to run the energy management module, in event of the loss of a node currently running the energy management module.

30. The system for distributed energy generation according to claim 28, in which every energy generating node is called upon to elect from among themselves a new node to run the energy management module, in event of the loss of a node currently running the energy management module.
